(19) United States
(12) Patent Application Publication
(10) Pub. No.: US 2013/0047973 A1
(43) Pub. Date: Feb. 28, 2013

(54) Controlled Draft Grill System

(71) Applicant: Billy Nicks, Rowlett, TX (US)

(72) Inventor: Billy Nicks, Rowlett, TX (US)

(21) Appl. No.: 13/600,185

(22) Filed: Aug. 30, 2012

Related U.S. Application Data
(60) Provisional application No. 61/529,246, filed on Aug. 30, 2011.

(51) Int. Cl. A47J 37/07

(52) U.S. Cl. 126/25 R; 126/15 A

(57) ABSTRACT

In one embodiment, the controlled draft grill system comprises a housing, an air flow driver, and an outflow. The housing further comprises a top section and a bottom section hingedly connected forming an interior enclosure which defines a cooking chamber. Disposed within the cooking chamber is a resting surface, from which flame or heat may emanate. The air flow driver comprises an air current device coupled to at least one conduit at a first end. A second end of the conduit is joined to the housing at a sealed aperture. The housing contains an opening distal to the sealed aperture. An outflow extends outwardly from the housing, such that the conduit, the cooking chamber, and the outflow are in fluid communication.

### PRIORITY

The present invention claims priority to provisional application 61/529,246, which has a filing date of Aug. 30, 2011, which is hereby incorporated by reference.

### BACKGROUND

1. Field of the Invention

The present invention relates to cooking appliances, more specifically to a grilling systems.

2. Description of the Related Art

Outdoor grilling is a common pastime and method of preparing food. The conventional grill comprises a top section and a bottom section. The top section and the bottom section are joined in a clamshell configuration, presenting a cooking chamber in the interior region. The sections are commonly hingedly joined, enabling the top section to pivot relative to the bottom section in order to provide access to the cooking chamber. An interior bottom wall presents a resting surface for a heat source within the cooking chamber. A grilling surface, typically a grate, is disposed within the cooking chamber, above and proximate the heat source. The top section may further comprise a disc having a tab rotatably fixed to the upper section of the grill. The disc includes plural apertures spaced apart with similarly dimensioned corresponding apertures in the top section of the grill. Air flow is altered by rotating the disc so that a portion of the apertures of the disc and apertures of the top section overlap, permitting limited controlled air flow from the cooking chamber.

The food is placed within the cooking chamber and cooked via direct heat from the flame of the heat source and from convection of the heat that is inside the chamber as a result of the heat source, thus control of the flame and interior temperature is preferable for quality food preparation.

In order to start a charcoal fire, the charcoal is placed in a pyramid on the bottom wall resting surface and doused with lighter fluid. The charcoal is then ignited, possibly producing a tall flame, and the user waits until the cooking chamber reaches a desired temperature, commonly about twenty to thirty minutes. Then the user evenly distributes the charcoal across the resting surface using an instrument such as tongs, again risking exposure to the high temperatures.

The conventional grills also suffers from inconsistent food quality because of the inability to reach a desired temperature and maintain the desired temperature. The grills lack a means to finely control combustion and air flow, thus the ability to control temperature within the cooking chamber is limited. The issue of temperature control is compounded when the user opens the top section of the grill, which may be necessary to add, remove, or observe the food being cooked. The disc fixed to the top section of the grill may allow air flow from the cooking chamber, but the air flow control is limited. Moreover, because the disc is directly fixed to the top section of the grill, it tends to become hot, making it difficult to manipulate, again making it difficult to control air flow.

The art has failed to provide a grilling system which enables fine control of temperature within the cooking chamber and minimize resources used while cooking.

### SUMMARY

In one embodiment, the controlled current grill system comprises a housing bounding a cooking chamber, a resting surface disposed within the cooking chamber, an aperture in the housing, and an opening disposed distally to the aperture. An air flow driver comprising a device for producing air current and a conduit. The conduit has a first end, a second end, and a hollow interior and the conduit is sealably coupled to the air current device proximate the first end and sealably coupled to the aperture proximate the second end, whereby the air current device, the conduit, the cooking chamber, and the opening present a fluid communication channel.

These and other features, aspects, and advantages of the invention will become better understood with reference to the following description, and accompanying drawings.

### BRIEF DESCRIPTION OF THE DRAWINGS

FIG. 1 depicts a side view of an embodiment of the current invention;

FIG. 2 depicts a top perspective view of an alternate embodiment of the current invention;

FIG. 3 depicts a top perspective view of the fan and reducer of FIG. 2;

FIG. 4 depicts an air conduit coupled to a section of the grill system of FIG. 1;

FIG. 5 depicts a top perspective view of the embodiment of FIG. 1 in a different state;

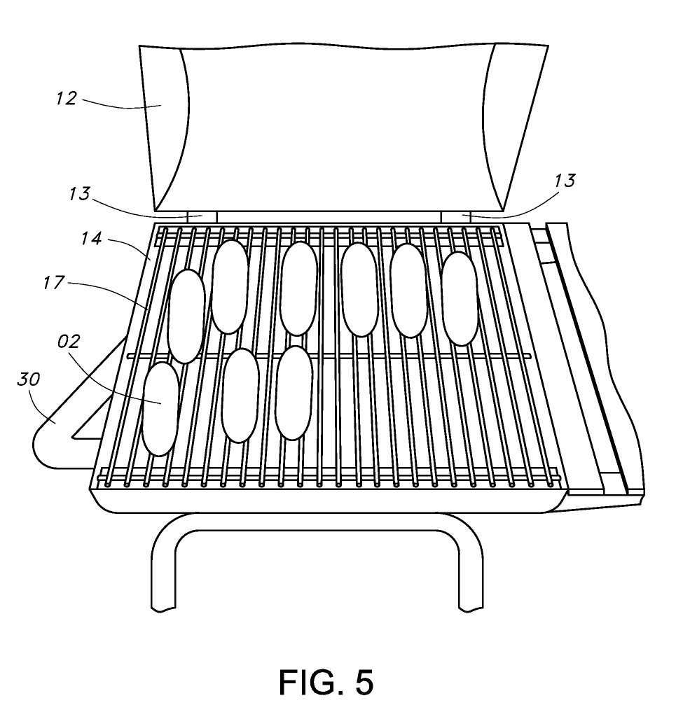

FIG. 6 depicts a side perspective view of the outflow of FIG. 1; and

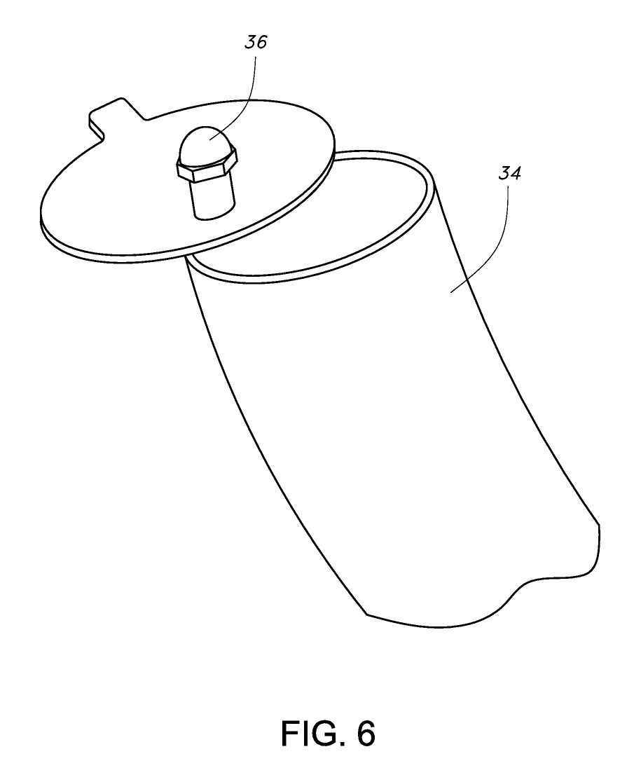

FIG. 7 depicts a top perspective view of a portion of the cooking chamber of FIG. 1.

### DETAILED DESCRIPTION

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

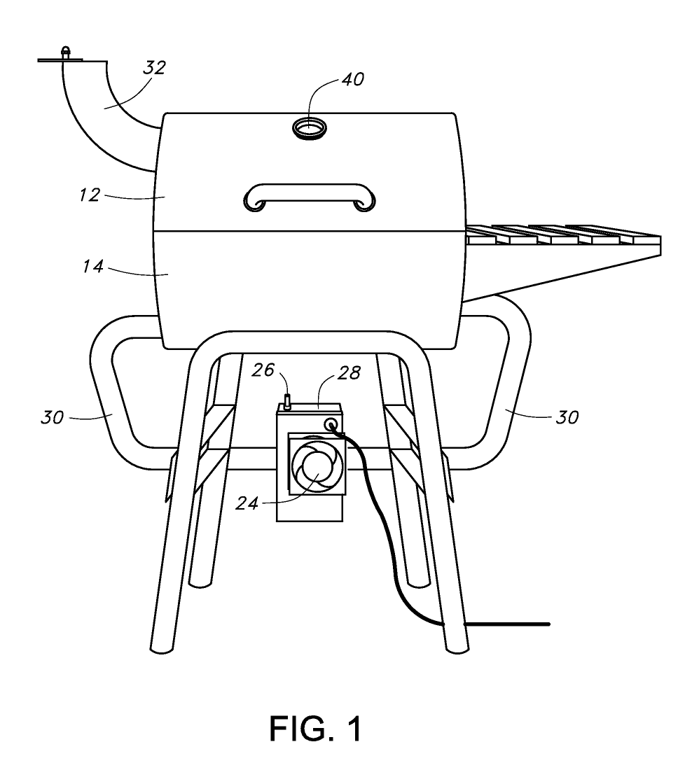

In a first embodiment, the grill system 10 is intended for use in preparing food 06 over an open heat source 04. Referring to FIG. 1, an embodiment of the controlled draft grill system 10 according to the current invention is illustrated. The grill system 10 includes housing 11, an air flow driver 20, and an outflow 32. The housing 11, air flow driver 20, and outflow 32 are coupled together such that a complete fluid communication channel exists from the ambient environment through the airflow channel driver 20, through the interior of the housing 11, through the outflow 32, and back to the ambient environment. Put another way, gas can travel selectively, completely through the channel.

It should be understood that the housing can be that of a grill, a smoker, or similar device. The housing 11 of the current embodiment includes a top section 12 and a corresponding bottom section 14. The bottom section 14 has a recess in its inner periphery and presents a rim at its outer periphery. It has an inner surface and outer surface. The top section 12 also has a recess in its inner periphery and presents a similarly dimensioned rim at its outer periphery. It has an inner surface and outer surface. The top section 12 and bottom section 14 are oriented in an opposing relationship, such that the inner surface of each section 12 14 is facing each other. The top section 12 and the bottom section 14 are mated, defining a seal at their respective rims and are preferably hingedly connected 13 presenting a larger interior enclosure of a configurable volume which defines a cooking chamber 08. The inner surface of the bottom section 14 presents a resting surface 16.

On or proximate the resting surface 16, preferably in the bottom section 14, is disposed a structure for supporting the heat source 04. Suitable heat sources in combustible fuels such as charcoal, briquettes, firewood, gas, or the like. Also disposed in the cooking chamber 08 is a cooking surface 17, which is depicted as a grate 06 in the figures.

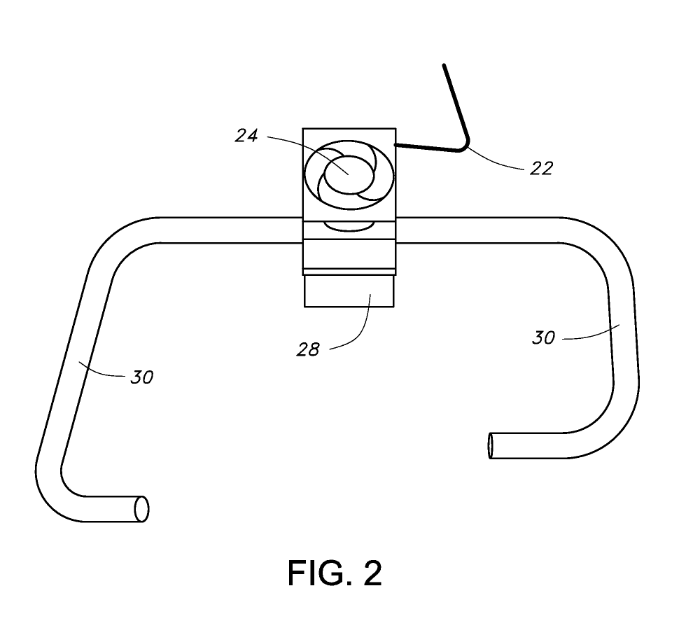

The controlled draft grill system 10 includes an air flow driver 20 operable to produce an air current, directing air from the ambient environment to the cooking chamber 08. Referring to FIG. 2, the air flow driver 20 of the current embodiment includes a fan 24, a power supply 22, at least one coupler 28, and at least one segment of conduit 30.

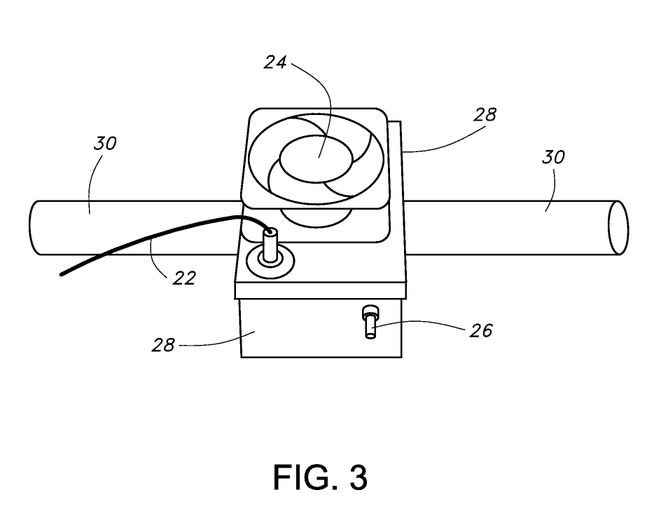

A fan 24, air multiplier, or other device which produces a current of air can be employed in the current invention. Referring to FIG. 3, a suitable fan 24 is one which can move a sufficient volume of air through the complete fluid communication channel, taking into account the volume of the cooking chamber 08, the volume of the interior of the conduit 30, volume of gases produced in combustion of the heat source 04, and other air current control factors. The fan's 24 blade length, pitch, speed, or power rating include elements which may be configured to produce a suitable air flow.

The preferred fan is one which is powered by an electric motor, making it available to be powered by battery or alternating current (AC) power supply. The depicted power supply 22 is AC from a standard household outlet, although DC current can also used. The air flow driver 20 includes a fan control 26 to power the fan 24. FIG. 3 depicts a switch to control power to the fan. In an alternative configuration, a fan control 26 includes a potentiometer operable to enable selective, granular air current control to a user of the grill system 10.

The input side of the fan 24 is unimpeded, while the output side of the fan 24 is channeled to a first end of at least one length of conduit 30. A coupler 28 (shown as a reducer) is used to capture and direct the fan's 24 output. The coupler 28 is also attached and sealed to a first end of at least one length of conduit 30, directing the fan's 24 output through the hollow interior of the conduit 30. In the preferable configuration, the coupler 28 is mated with the first end of two conduits 30, with the input air flow direction of each conduit 30 being substantially 180° relative to each other.

The length, width, and geometry of the cross-section of the conduits 30 vary according to the requirement. However, it is preferable that each conduit 30 have two angular folds, each of about 90° in order to redirect the air flow a total of about 180° at its second end relative to its input air flow direction and generally parallel to resting surface 16. In alternate configurations, the distal end is slightly offset from the plane defined by the resting surface 16. It should also be noted that the preferred composition of the conduit and seal is one that can withstand grilling temperatures, yet has a relatively low thermal coefficient in order to minimize heat transfer from the housing 11.

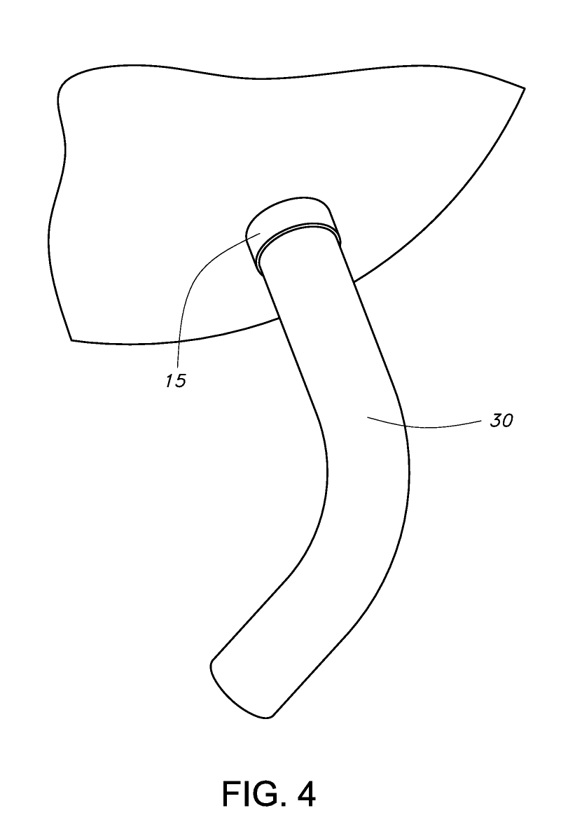

Referring to FIG. 4, a second end of a conduit 30 and an aperture 15 in the housing 11 are shown. The housing 11 of the current embodiment, preferably the bottom section 14, includes at least one aperture 15 adapted for sealable receipt of the second end of the conduit 30. In the preferable configuration, the bottom section 14 includes two apertures 15 on opposing sidewalls of the bottom section 14 of the housing 11. Moreover, the apertures 15 are preferably disposed substantially in the same plane as the resting surface for the heat source 04, such that the input air flow from the conduit 30 is directed over the heat source 04, as is illustrated in FIG. 1.

To complete the fluid communication channel, a channel from the cooking chamber 08 to the ambient environment is necessary. An opening 18 in the cooking chamber 08 is included, preferably distal to the apertures 15 and proximate the peak vertical height of the top section 12 of the housing 11. The opening 18 sealably receives a first end of an outflow 32. At the distal, second end of the outflow 32 is a damper 38. The damper 38 includes a movable plate dimensioned to cover the second opening present by the outflow 32. The damper is preferably rotatably fastened to the second, distal end of the outflow 32, where it can be manipulated to selectively control air flow, enabling complete air flow, partial air flow, or impeded air flow states.

It is to be understood that the following nonexclusive configurations can be altered to control the draft through the cooking chamber 08 when the system is configured—the size of the fan 24, the speed of rotation of the fan 24, the pitch of the blades of the fan 24, the length of the conduit 30, the width of the conduit 30, the geometry of the conduit 30, the volume of the conduit 30, the volume of the cooking chamber 08, the length of the outflow 32, the geometry of the outflow 32 , and the damper 38 dimensions.

To use the controlled draft grill system 10, the housing apertures 15 are created in the bottom section 14 of the housing. The distal ends of the conduits 30 of the air flow driver 20 are introduced to the apertures 15. Charcoal 04 is placed on the resting surface 16 of the bottom section 14 of the grill system. A small amount of lighter fluid is placed on the charcoal 04 and the charcoal 04 is ignited. The charcoal is brought to an ember state either by allowing the flame to subside or limiting the air flow. Next, the power control 26 of the fan 24 is activated. Optionally, the damper 38 of the outflow 32 is adjusted. After the grill is at the desired temperature, the food is placed on the cooking surface 17.

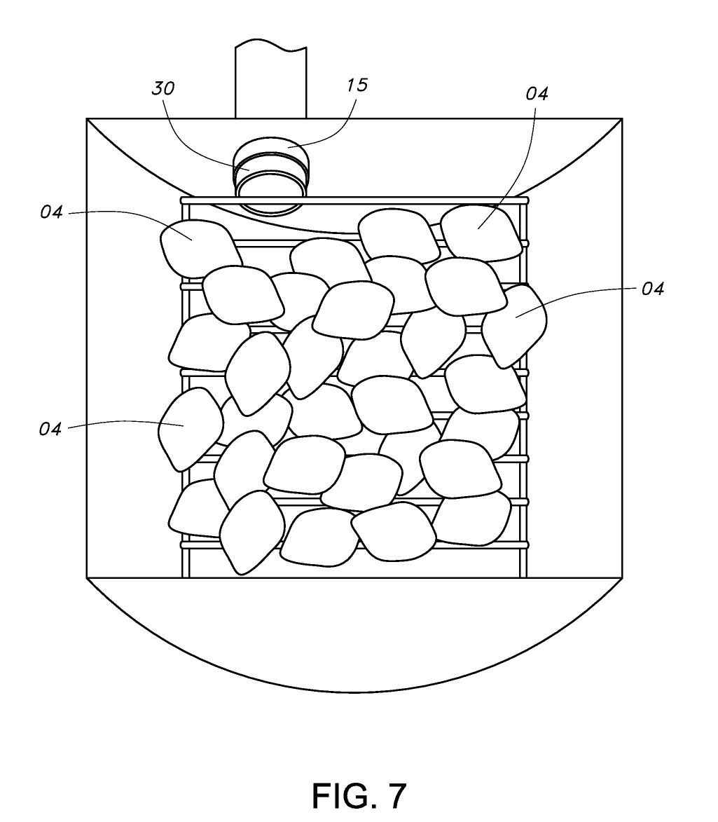

In an implementation of the above embodiment, a cooking chamber 08 of a Lowe's “BBQ Grillware”™ model with an estimated 14.5″×17.5″ cooking surface was employed. A fan 24 of approximately 4″ in diameter which displaces about 117 ft³/minute of air was used in the air flow driver 20. The fan 24 was coupled to two 1.5″ diameter tubular aluminum tubes of about 30″ in length which included two angular bends that redirected the airflow about 180° from the air flow input. Two apertures 15 of about 1.5″ width were included in the bottom section 14 of the housing at the same height as the heat source 04 and on opposing sides of the housing. The distal, second ends of the conduits 30 were introduced to the two 1.5″ apertures 15 and sealed. A single layer of charcoal 04 was evenly spread across the resting surface 16 as shown in FIG. 7 and a small amount of lighter fluid, estimated to be less than a teaspoon, was individually applied to each piece of charcoal 04. The lighter fluid was allowed to soak in the charcoal 04 for about one minute and then the charcoal 04 was ignited. After the initial flame subsided and part of the charcoal 04 was white hot, wood chips were added in the spaces between the charcoal 04. The fan 24 was activated and the damper 38 was placed in an intermediate position. The cooking chamber 08 was brought to a constant temperature of about 370° in less than fifteen minutes. To simulate opening the grill to monitor food, the top section 12 of the grill was opened until the temperature gauge 40 showed a reading of about 270°. The top section 12 was closed and the damper 38 was manipulated to block air flow. The temperature returned to 370° within three minutes. The single layer of charcoal 04 lasted about two hours at substantially consistent temperature, excepting the above simulation. The charcoal 04 was substantially completely combusted and only ash remained at the end of the approximate two hour duration.

Insofar as the description above and the accompanying drawings disclose any additional subject matter, the inventions are not dedicated to the public and the right to file one or more applications to claim such additional inventions is reserved.

What is claimed is:

1. A cooking grill system comprising:
a grill comprising housing bounding a cooking chamber, a resting surface disposed within said cooking chamber, an aperture in said housing, and an opening disposed distally to said aperture;
an air flow driver comprising a device for producing air current and a conduit;
said conduit having a first end, a second end, and a hollow interior; and
said conduit sealably coupled to said air current device proximate said first end and sealably coupled to said aperture proximate said second end, whereby said air current device, said conduit, said cooking chamber, and said opening present a fluid communication channel.

2. The system of claim 1 further comprising an outflow having a proximal end, a distal end, and a hollow interior;
said outflow sealably joined to said opening of said housing.

3. The system of claim 2 further comprising a damper movably joined to said outflow proximate said distal end of said outflow, with said damper selectively manipulable to control air flow from said outflow.

4. The system of claim 1 wherein said air current device comprises a fan.

5. The system of claim 1 wherein said air current device comprises an air multiplier.

6. The system of claim 1 wherein said air current device comprises a compressed gas store.

7. The system of claim 1 wherein said aperture is substantially coplanar with the plane presented by said resting surface.

8. The system of claim 1 wherein said aperture is slightly and upwardly offset with the plane presented by said resting surface.

9. The system of claim 1 wherein said housing further comprises a second aperture; a second conduit, said second conduit having a first end, a second end, and a hollow interior; and said second conduit sealably coupled to said air current device proximate said first end and sealably coupled to said second aperture proximate said second end.

10. A controlled current system system adapted for joinder with a grill having housing bounding a cooking chamber, a resting surface disposed within said cooking chamber, an aperture in said housing, and an opening disposed distally to said aperture, said controlled current system comprising:
an air flow driver comprising a device for producing air current and a conduit;
said conduit having a first end, a second end, and a hollow interior; and
said conduit sealably coupled to said air current device proximate said first end and adapted for sealably coupling to said aperture proximate said second end, whereby said air current device, said conduit, said cooking chamber, and said opening present a fluid communication channel.

11. The system of claim 10 further comprising an outflow having a proximal end, a distal end, and a hollow interior;
said outflow adapted for sealably joining to said opening of said housing.

12. The system of claim 11 further comprising a damper movably joined to said outflow proximate said distal end of said outflow, with said damper selectively manipulable to control air flow from said outflow.

13. The system of claim 10 wherein said air current device comprises a fan.

14. The system of claim 10 wherein said air current device comprises an air multiplier.

15. The system of claim 10 wherein said air current device comprises a compressed gas store.

16. The system of claim 10 further comprising a second conduit having a first end, a second end, and a hollow interior; and
said second conduit sealably coupled to said air current device proximate said first end and adapted for sealably coupling to a second aperture in said housing proximate said second end.

17. A cooking grill system comprising:
a grill comprising housing bounding a cooking chamber, a resting surface disposed within said cooking chamber, a first aperture in said housing, a second aperture in said housing distal to said first aperture, and an opening disposed distally to said apertures;
an air flow driver comprising a device for producing air current and a first conduit and a second conduit;
said first conduit having a first end, a second end, and a hollow interior; and
said first conduit sealably coupled to said air current device proximate said first end and sealably coupled to said first aperture proximate said second end
said second conduit having a first end, a second end, and a hollow interior; and
said second conduit sealably coupled to said air current device proximate said first end and sealably coupled to said second aperture proximate said second end;
an outflow having a proximal end, a distal end, and a hollow interior, said outflow sealably joined to said opening of said housing;
a damper movably joined to said outflow proximate said distal end of said outflow, with said damper selectively manipulable to control air flow from said outflow;
whereby said air current device, said first and second conduits, said cooking chamber, and said outflow present a fluid communication channel.

18. The system of claim 17 wherein said apertures are substantially coplanar with the plane presented by said resting surface.

19. The system of claim 17 wherein said apertures are slightly and upwardly offset with the plane presented by said resting surface.
